(19) United States
(12) Patent Application Publication
(10) Pub. No.: US 2014/0308099 A1
(43) Pub. Date: Oct. 16, 2014

(54) PILL PICKING APPARATUS

(71) Applicant: HON HAI PRECISION INDUSTRY CO., LTD., New Taipei (TW)

(72) Inventor: KUO-MING LAI, New Taipei (TW)

(73) Assignee: HON HAI PRECISION INDUSTRY CO., LTD., New Taipei (TW)

(21) Appl. No.: 14/231,936

(22) Filed: Apr. 1, 2014

(30) Foreign Application Priority Data
Apr. 12, 2013 (TW) 102113011

(51) Int. Cl. A61J 7/00

(52) U.S. Cl. CPC A61J 7/0076
USPC 414/304

(57) ABSTRACT

A pill picking apparatus includes a main arm, a picking device mounted to the main arm, and a transfer mechanism. The main arm is rotatable about a first axis and defines an opening. The picking device is adapted to pick a pill from a pill box. The transfer mechanism includes a transfer cam being rotatable about a second axis, and a driving wheel mounted to the transfer cam and received in the opening of the main arm. When the transfer cam rotates about the second axis, the driving wheel is rotated about the second axis by the transfer cam and presses an edge of the opening of the main arm, to drive the main arm to rotate about the first axis.

### CROSS-REFERENCE TO RELATED APPLICATIONS

This application claims priority to Taiwan Patent Application No. 102113011 filed on Apr. 12, 2013 in the Taiwan Intellectual Property Office, the contents of which are hereby incorporated by reference. Relevant subject matter is disclosed in co-pending U.S. patent applications entitled “PILL PICKING APPARATUS”, Attorney Docket Number US51422, U.S. application Ser. No. [to be advised], filed on the same day as the present application.

### FIELD

The present disclosure generally relates to pill dispensers, and particularly relates to pill picking apparatuses of automatic pill dispensers.

### BACKGROUND

Automatic pill dispensers are commonly used to used to help individuals, such as the elderly or chronically ill, take their prescription medication, OTC medication or daily supplements at a given date and time. Pill dispensers often include a pill box for storing solid pills and a pill picking apparatus for picking pills from the pill box. However, when the remaining amount of pills left in the pill box is small, it becomes more difficult for the picking apparatus to pick pills from the pill box.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is an isometric view of an embodiment of a pill dispenser.

FIG. 2 is similar to FIG. 1, but the pill dispenser is viewed from another aspect.

FIG. 3 is an exploded view of the pill dispenser of FIG. 1.

FIGS. 4-15 show a process of the pill picking apparatus picking a pill from a pill box of the pill dispenser of FIG. 1.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

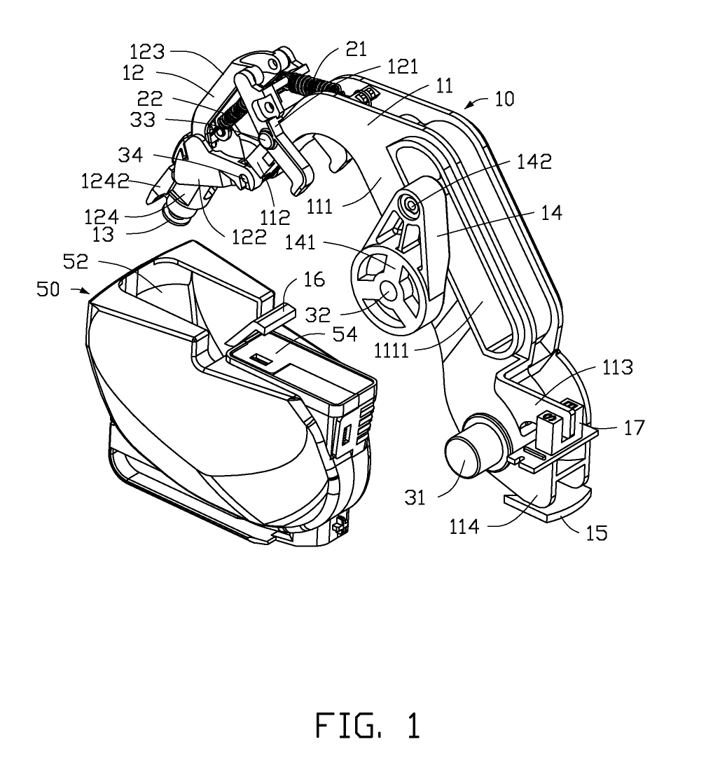

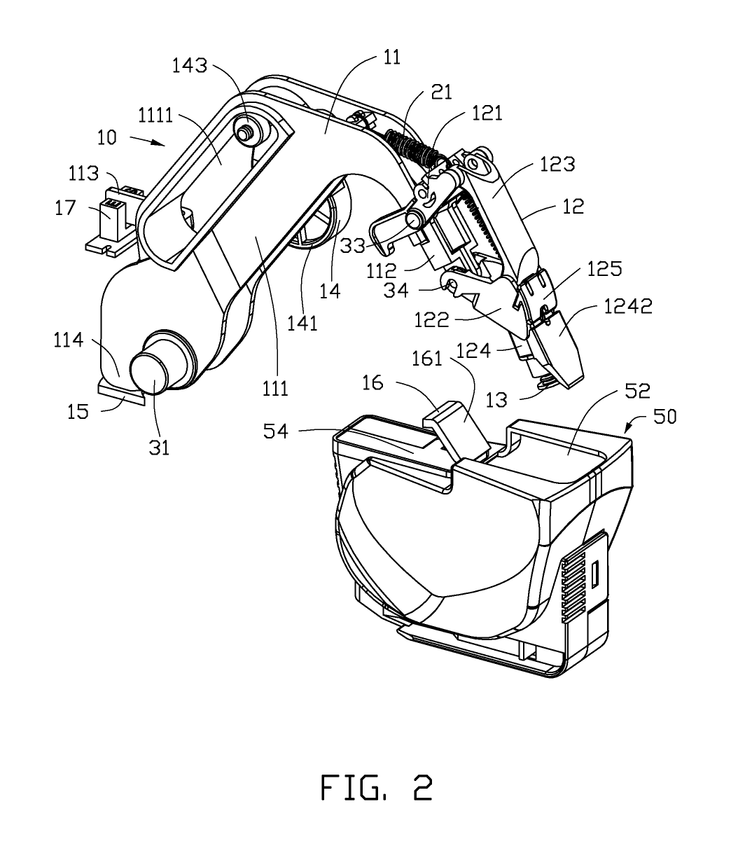

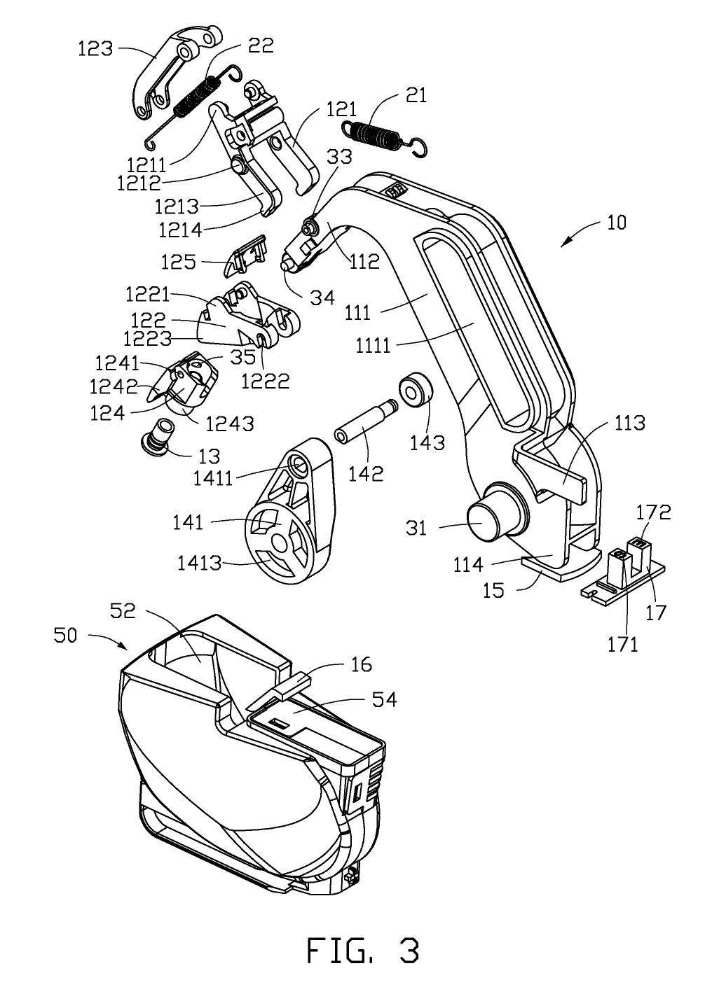

FIGS. 1-4 show an embodiment of a pill dispenser. The pill dispenser includes a pill picking apparatus 10 and a pill box 50. A plurality of pills may be stored in the pill box 50. The pill picking apparatus 10 may pick pills from the pill box 50.

The pill box 50 includes an interior wall 51 which forms a storage cavity 53 for storing pills. The pill box 50 defines an opening 52 for allowing access to the storage cavity 53 of the pill box 50.

In at least one embodiment, the pill picking apparatus 10 includes a main arm 11, a linkage mechanism 12, a holder 124, a picking device such as a vacuum nozzle 13, a transfer mechanism 14, a first blocking member 16, a second blocking member 15, and a position sensor 17.

The main arm 11 is rotatable about a first axis 31. The main arm 11 includes a main body 111, an installation portion 112, a breaking portion 113, and a contacting portion 114. The main body 111 defines an opening 1111. The opening 1111 is bound by two opposite straight edges and two opposite curved edges. The installation portion 112 extends from an upper end of the main body 111, and the breaking portion 113 extends from a lower end of the main body 111. The installation portion 112 is substantially perpendicular to the main body 111. The contacting portion 114 extends from the lower end of the main body 111 and is adjacent to the breaking portion 113.

The transfer mechanism 14 includes a transfer cam 141, a driving shaft 142, and a driving wheel 143. The transfer cam 141 is rotatable about a second axis 32. A free end of the transfer cam 141 defines a fixing hole 1411. A first end of the driving shaft 142 is inserted into the fixing hole 1411, so that the driving shaft 142 is fixed to the transfer cam 141 and may be rotated about the second axis 32 by the transfer cam 141. The driving shaft 142 is substantially perpendicular to the transfer cam 141. The driving wheel 143 is mounted to a second end of the driving shaft 142 and is rotatable about the driving shaft 142. The second axis 32 is above and to the left of the first axis 31. The transfer cam 141 defines one or more slots 1413 for connecting to a motor (not shown), such that the transfer cam 141 may be rotated about the second axis 32 by the motor.

The second end of the driving shaft 142 is received into the opening 1111 of the main body 111. The driving wheel 143 is received into the opening 1111 of the main body 111. When the driving shaft 142 is rotated by the transfer cam 141 about the second axis 32, the driving wheel 143 presses an edge of the opening 1111 of the main body 111 and drives the main body 1111 to rotate about the first axis 31.

The linkage mechanism 12 includes a first linkage arm 121, a second linkage arm 122, and a third linkage arm 123.

The first linkage arm 121 includes a first connecting end 1211, a first pivot portion 1212, and a contacting end 1213. The first pivot portion 1212 is pivotally coupled to the installation portion 112 of the main arm 11. The first linkage arm 121 is rotatable about a third axis 33. The first connecting end 1211 and the contacting end 1213 are located at opposite sides of the first pivot portion 1212. The contacting end 1213 includes a protrusion 1214 extending downward.

The second linkage arm 122 includes a second connecting end 1221, a second pivot portion 1222, and a third connecting end 1223. A projection of the second linkage arm 122 is substantially triangular. The second connecting end 1221, the second pivot portion 1222, and the third connecting end 1223 are substantially located at the three corners of a triangle. The second pivot portion 1222 is pivotally coupled to the installation portion 112 of the main arm 11. The second linkage arm 122 is rotatable about a fourth axis 34.

A first end of the third linkage arm 123 is pivotally coupled to the first connecting end 1211 of the first linkage arm 121. A second end of the third linkage arm 123 is pivotally coupled to the second connecting end 1221 of the second linkage arm 122. When the first linkage arm 121 is rotated about the third axis 33, the third linkage arm 123 is moved by the first linkage arm 121, thus driving the second linkage arm 122 to rotate about the fourth axis 34.

The holder 124 includes a third pivot portion 1241, a shovel 1242, and a receiving portion 1243. The third pivot portion 1241 is pivotally coupled to the third connecting end 1223 of the second linkage arm 1221. The holder 124 is rotatable about a fifth axis 35. The vacuum nozzle 13 is received and mounted in the receiving portion 1243. The shovel 1242 is located on an outer side of the receiving portion 1243. A length of the shovel 1242 is greater than a length of the receiving portion 1243. The shovel 1242 is substantially flat. The vacuum nozzle 13 is connected to a pump or cylinder (not shown) to suck a pill from the pill box 50.

In one embodiment, the linkage mechanism 12 includes a cover 125. The cover 125 is mounted to the second linkage arm 122 and the third linkage arm 123. The cover 125 covers a gap between the second linkage arm 122 and the third linkage arm 123 to prevent a pill from getting stuck in the gap.

The position sensor 17 is substantially U-shaped. The position sensor 17 includes a signal transmitter 171 and a signal receiver 172. The signal transmitter 171 and the signal receiver 172 face each other. The signal transmitter 171 transmits a signal, e.g., an optical signal, to the signal receiver 172. When the breaking portion 113 of the main arm 11 is moved to a position between the signal transmitter 171 and the signal receiver 172 and breaks the signal transmission between the signal transmitter 171 and the signal receiver 172, the position sensor 17 determines that the main arm 11 is located in an initial position. When the breaking portion 113 of the main arm 11 is not located between the signal transmitter 171 and the signal receiver 172 and the signal transmission recommences, the position sensor 17 determines that the main arm 11 has left the initial position.

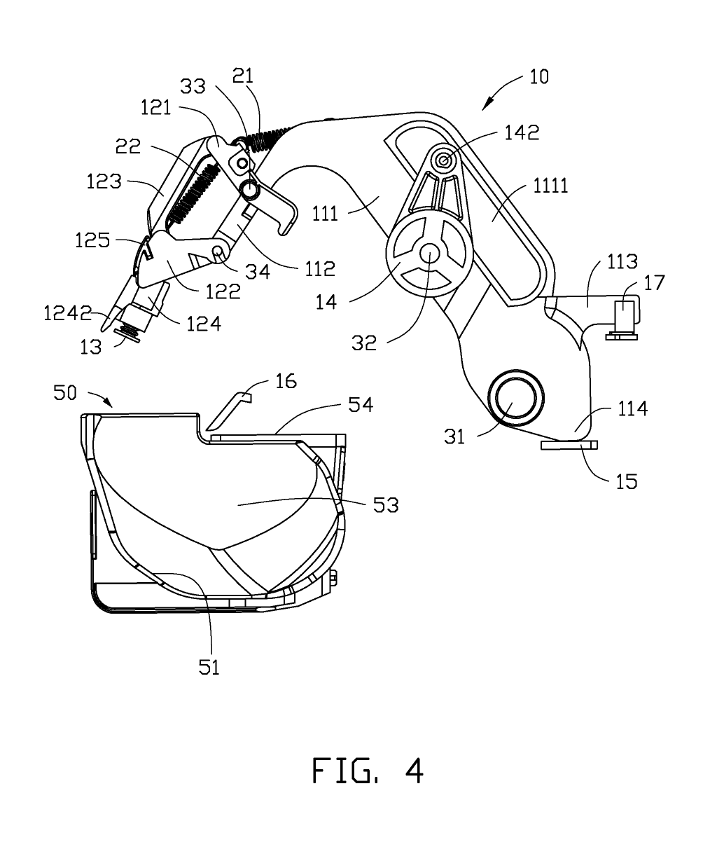

When the main arm 11 is located in the initial position, the contacting portion 114 of the main arm 11 abuts against the second blocking member 15, thereby preventing the main arm 11 from rotating about the first axis 31 in a clockwise direction (from the view in FIG. 4). The second blocking member 15 is flat and lies horizontally.

The first blocking member 16 is located on a top wall 54 of the pill box 50 and adjacent to the opening 52 of the pill box 50. The first blocking member 16 includes a contacting surface 161 which is inclined relative to the top wall 54 of the pill box 50. In one embodiment, a lower edge of the blocking member 16 is located below the first axis 31 and a top edge of the blocking member 16 is located above the first axis 31.

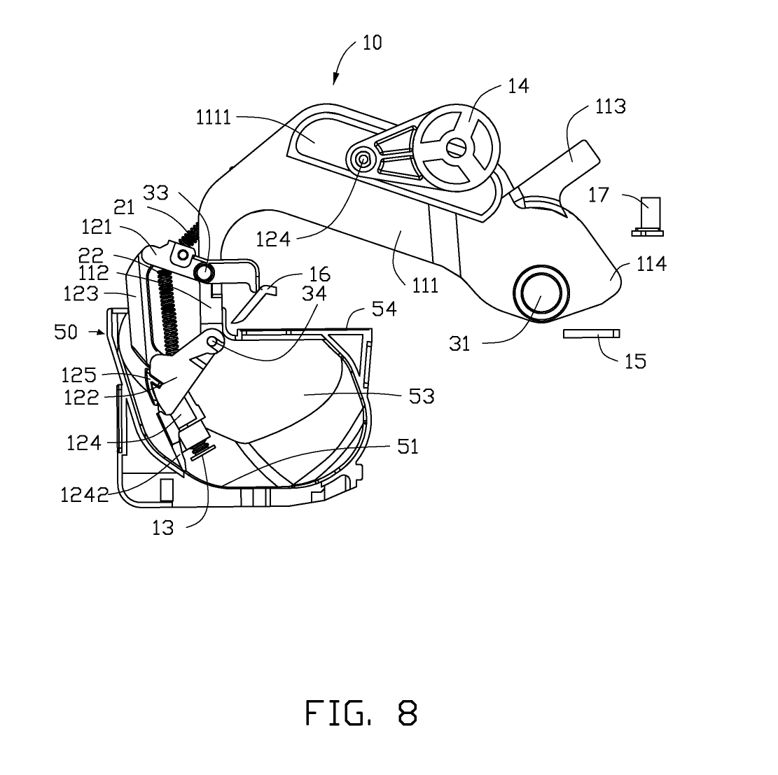

When the main arm 11 moves in a counter-clockwise direction to a position where the contacting end 1213 of the first linkage arm 121 abuts against the contacting surface 161 of the first blocking member 16 and the main arm 11 continues moving in a counter-clockwise direction (according to the view in FIGS. 8-10), the blocking member 16 drives the first linkage arm 121 to rotate about the third axis 33 in a counter-clockwise direction, and further drives the third linkage arm 123 to rotate about the fourth axis 34 in a counter-clockwise direction.

In some embodiments, a radius of rotation of the main arm 11 about the first axis 31 is three times greater than a radius of rotation of the driving shaft 142 about the second axis 32. A vertical distance between the first axis 31 and the second axis 32 is three and one haft times greater than a horizontal distance between the first axis 31 and the second axis 32.

In one embodiment, the pill picking apparatus 10 includes a first resilient member 21 and a second resilient member 22. An end of the first resilient member 21 is connected to the first arm 11, and another end of the first resilient member 21 is connected to the first linkage arm 121. The first resilient member 21 applies a pulling force to the first linkage arm 121, so that the first linkage arm 121 is biased to rotate about the third axis 33 in a clockwise direction. An end of the second resilient member 22 is connected to the first linkage arm 121, and another end of the second resilient member 22 is connected to the holder 124. The second resilient member 22 applies a pulling force to the holder 124, so that the holder 124 is biased to rotate about the fifth axis 35. The first resilient member 21 and the second resilient member 22 may be extension springs.

The second resilient member 22 is located on an interior side of the third linkage arm 123 and the cover 125. When the linkage mechanism 12 enters the storage cavity 53 of the pill box 50, the second resilient member 22 is spaced from the pills stored in the pill box 50 by the third linkage arm 123 and the cover 125, so that the second resilient member 22 is prevented from touching and polluting the pills stored in the pill box 50.

The interior wall 51 of the pill box 50 has a curved surface. When the linkage mechanism 12 enters the storage cavity 53 of the pill box 50, the interior wall 51 guides the movement of the shovel 1242 of the holder 124.

In one embodiment, the first axis 31, the second axis 32, the third axis 33, the fourth axis 34, and the fifth axis 35 are parallel to each other.

FIGS. 4-15 show a process of the pill picking apparatus 10 picking a pill from the pill box 50.

In FIG. 4, the main arm 11 is located in an initial position. The contacting portion 114 of the main arm 11 abuts against the second blocking member 15. The blocking member 15 prevents the main arm 11 from rotating about the first axis 31 in the clockwise direction. The breaking portion 113 of the main arm 113 is located in a position between the signal transmitter 171 and the signal receiver 172 and breaks the signal transmission between the signal transmitter 171 and the signal receiver 172. The position sensor 17 thus determines that the main arm 11 is located in the initial position.

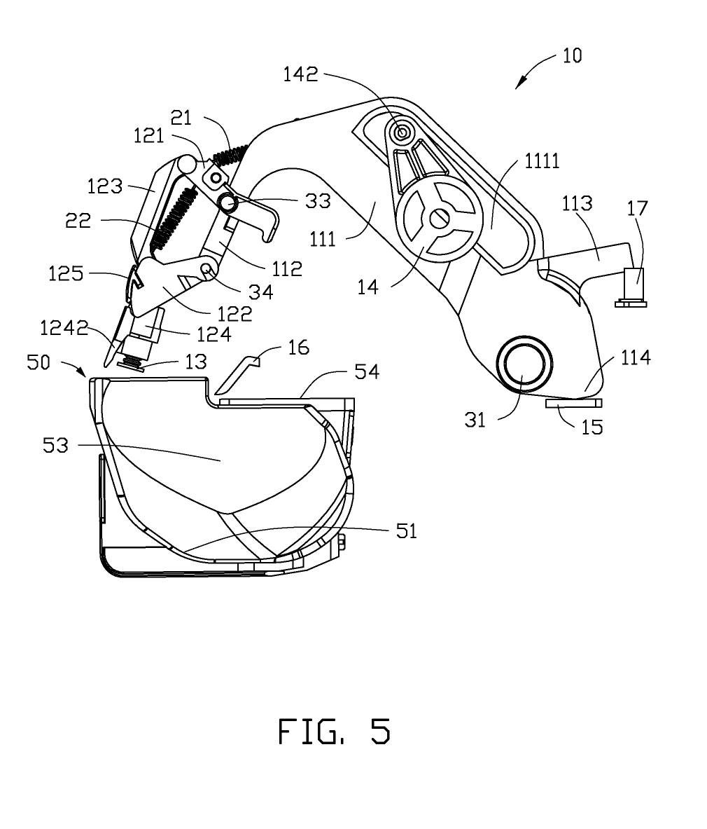

In FIG. 5, the transfer cam 141 of the transfer mechanism 14 starts rotating about the second axis 32 in a counter-clockwise direction. The driving wheel 143 of the transfer mechanism 14 presses an edge of the opening 1111 of the main arm 11, thus driving the main arm 11 to rotate about the first axis 31 in a counter-clockwise direction. The linkage mechanism 12 and the vacuum nozzle 13 are on the point of entering the storage cavity 53 of the pill box 50. The breaking portion 113 of the main arm 11 is about to leave the position sensor 17.

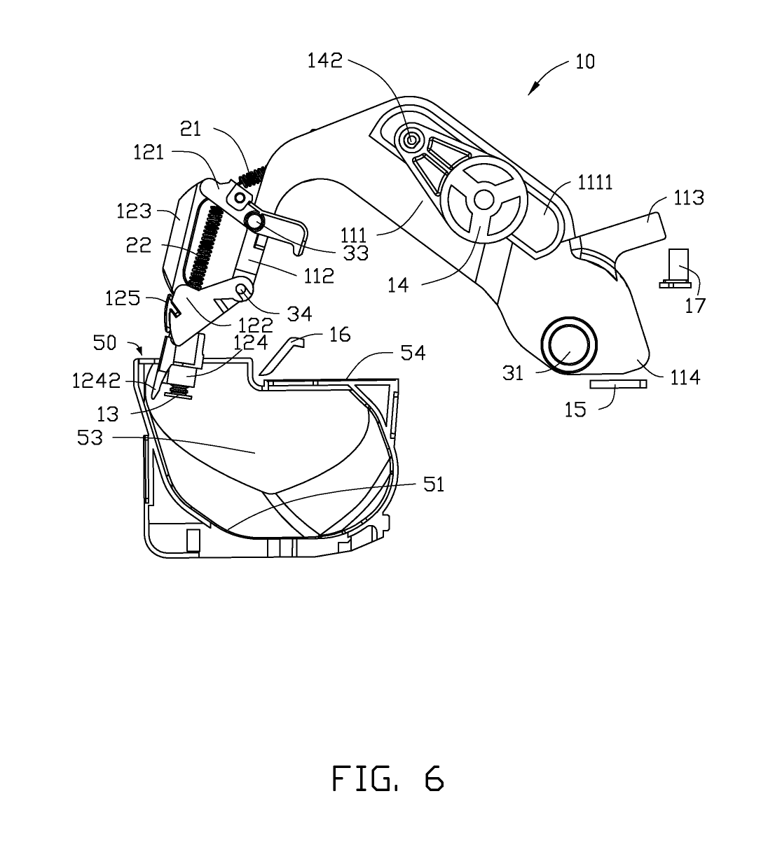

In FIG. 6, the transfer cam 141 of the transfer mechanism 14 continues rotating about the second axis 32 in a counter-clockwise direction. The driving wheel 143 of the transfer mechanism 14 continues pressing an edge of the opening 1111 of the main arm 11 and driving the main arm 11 to rotate about the first axis 31 in a counter-clockwise direction. The linkage mechanism 12 and the vacuum nozzle 13 enter the storage cavity 53 of the pill box 50. The breaking portion 113 of the main arm 11 has left the position sensor 17 enabling the signal transmission between the signal transmitter 171 and the signal receiver 172 to recommence. The position sensor 17 determines that the main arm 11 has left the initial position. In this position, the vacuum nozzle 13 may pick a pill if the storage cavity 53 of the pill box 50 is full of pills.

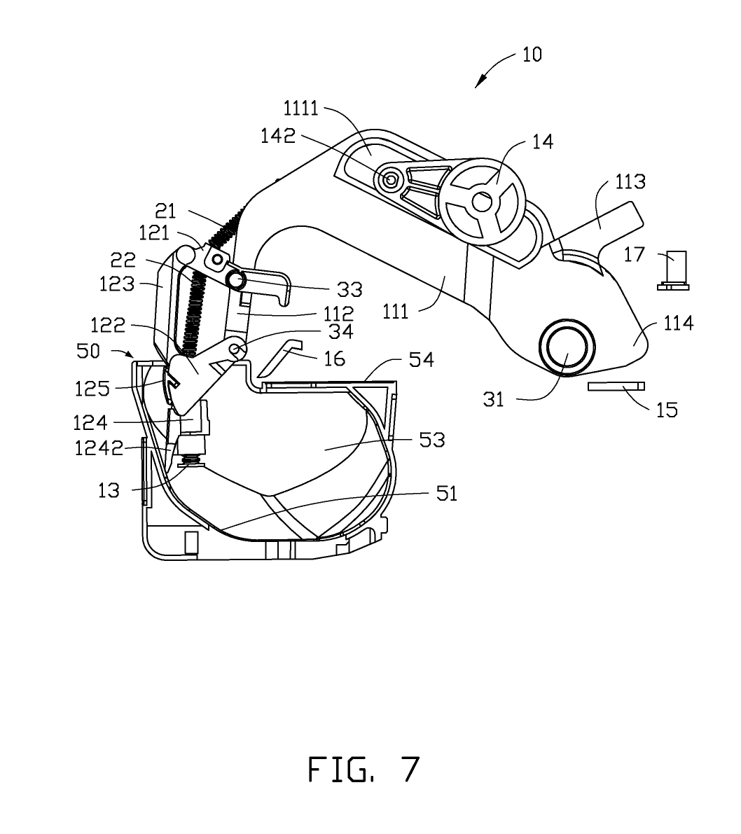

In FIG. 7, when the vacuum nozzle 13 does not pick a pill in the high position, the transfer cam 141 of the transfer mechanism 14 continues rotating about the second axis 32 in a counter-clockwise direction. The driving wheel 143 of the transfer mechanism 14 continues pressing an edge of the opening 1111 of the main arm 11 and driving the main arm 11 to rotate about the first axis 31 in a counter-clockwise direction. The shovel 1242 of the holder 124 contacts the curved surface of the interior wall 51 and moves down under the guidance of the interior wall 51. At this point, the vacuum nozzle 13 may pick a pill if the storage cavity 53 of the pill box 50 is haft full.

In FIG. 8, when the vacuum nozzle 13 does not pick a pill at this stage, the transfer cam 141 of the transfer mechanism 14 continues rotating about the second axis 32 in a counter-clockwise direction. The driving wheel 143 of the transfer mechanism 14 continues pressing an edge of the opening 1111 of the main arm 11 and driving the main arm 11 to rotate about the first axis 31 in a counter-clockwise direction. The protrusion 1214 of the contacting end 1213 of the first linkage arm 121 abuts against the contacting surface 161 of the first blocking member 16. The first blocking member 161 starts driving the first linkage arm 121 to rotate about the third axis 33 in a counter-clockwise direction. The shovel 1242 continues moving down under the guidance of the interior wall 51. At this stage, the vacuum nozzle 13 may pick a pill if the storage cavity 53 of the pill box 50 is almost empty of pills.

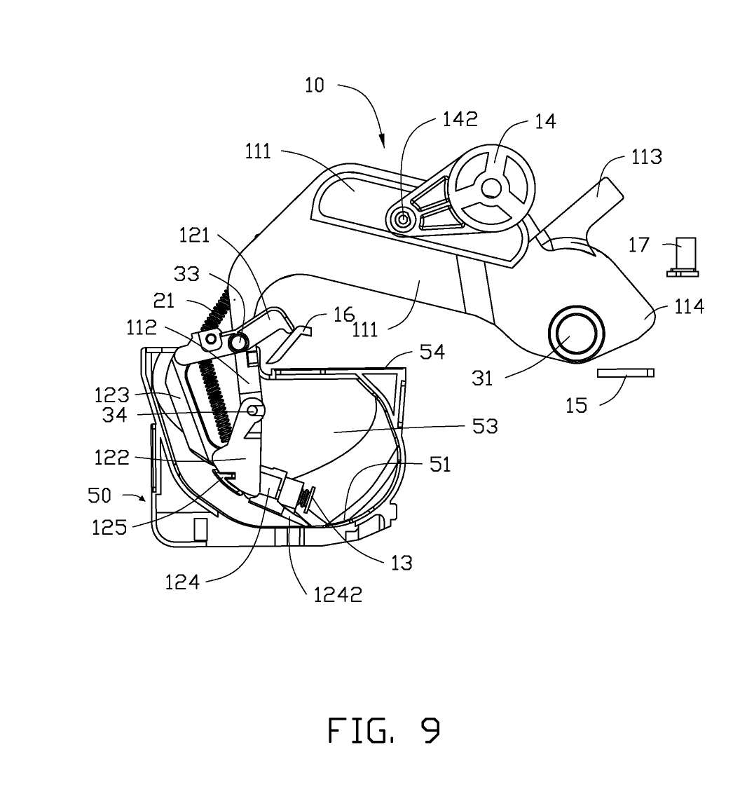

In FIG. 9, when the vacuum nozzle 13 does not pick a pill at this point, the transfer cam 141 of the transfer mechanism 14 continues rotating about the second axis 32 in a counter-clockwise direction. The driving wheel 143 of the transfer mechanism 14 continues pressing an edge of the opening 1111 of the main arm 11 and driving the main arm 11 to rotate about the first axis 31 in a counter-clockwise direction. The protrusion 1214 of the contacting end 1213 of the first linkage arm 121 abuts against the contacting surface 161 of the first blocking member 16. The first blocking member 161 continues driving the first linkage arm 121 to rotate about the third axis 33 in a counter-clockwise direction. The shovel 1242 continues moving down under the guidance of the interior wall 51. At the moment, the vacuum nozzle 13 may pick a pill resting at a bottom position of the storage cavity 53 of the pill box 50.

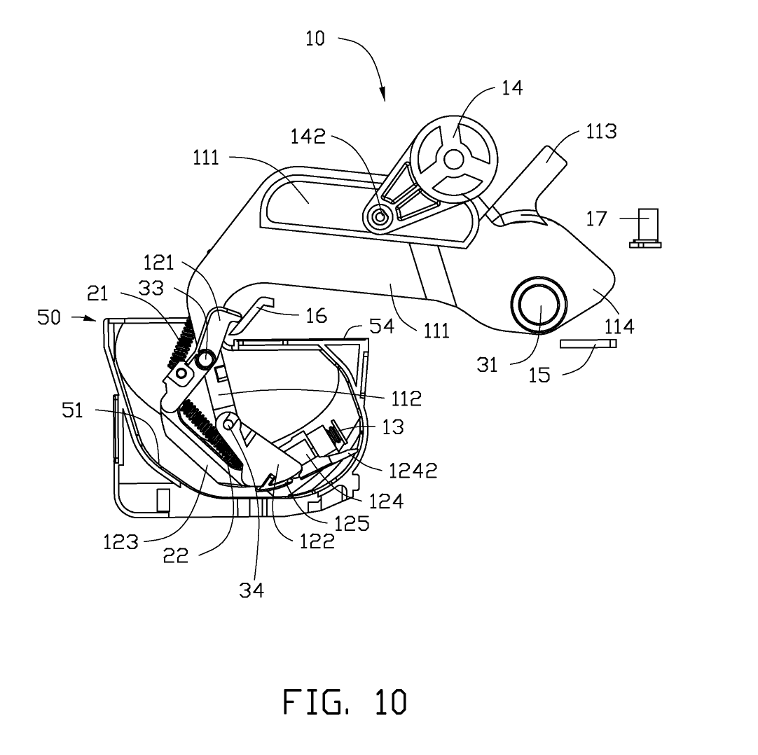

In FIG. 10, when the vacuum nozzle 13 does not pick a pill at this point, the transfer cam 141 of the transfer mechanism 14 continues rotating about the second axis 32 in a counter-clockwise direction. The driving wheel 143 of the transfer mechanism 14 continues pressing an edge of the opening 1111 of the main arm 11 and driving the main arm 11 to rotate about the first axis 31 in a counter-clockwise direction. The protrusion 1214 of the contacting end 1213 of the first linkage arm 121 abuts against the contacting surface 161 of the first blocking member 16. The first blocking member 161 continues driving the first linkage arm 121 to rotate about the third axis 33 in a counter-clockwise direction. The shovel 1242 of the holder 124 moves to the right and up under the guidance of the interior wall 51 until the vacuum nozzle 13 picks a pill in the storage cavity 53 of the pill box 50.

When the vacuum nozzle 13 has picked a pill from the pill box 50, the transfer cam 141 of the transfer mechanism 14 starts rotating about the second axis 32 in a clockwise direction. The driving wheel 143 of the transfer mechanism 14 presses an edge of the opening 1111 of the main arm 11 and drives the main arm 11 to rotate about the first axis 31 in a clockwise direction.

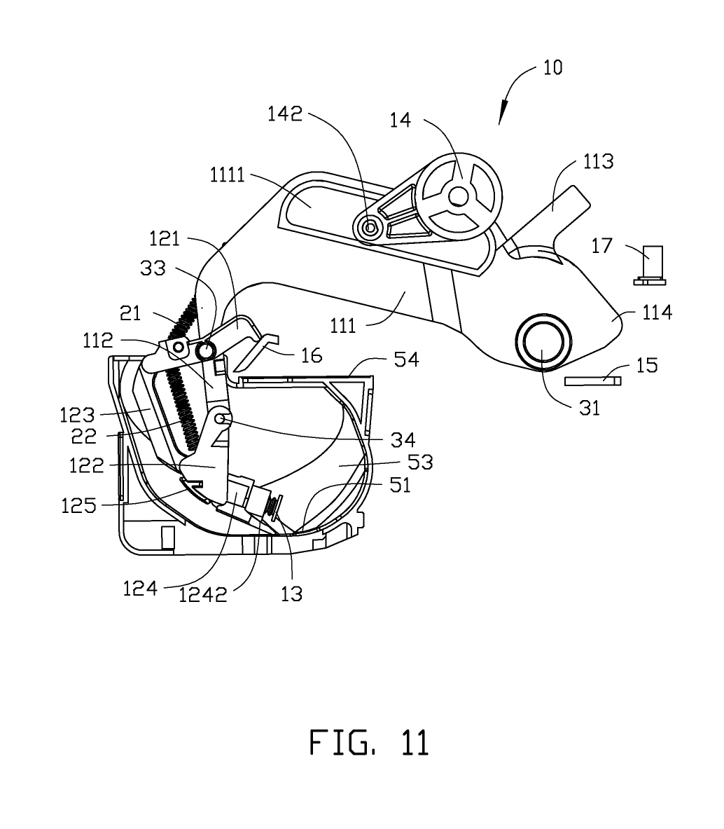

In FIG. 11, the transfer cam 141 of the transfer mechanism 14 continues rotating about the second axis 32 in a clockwise direction. The driving wheel 143 of the transfer mechanism 14 continues driving the main arm 11 to rotate about the first axis 31 in a clockwise direction. The shovel 1242 and the vacuum nozzle 13 move to the bottom position of the storage cavity 53 of the pill box 50.

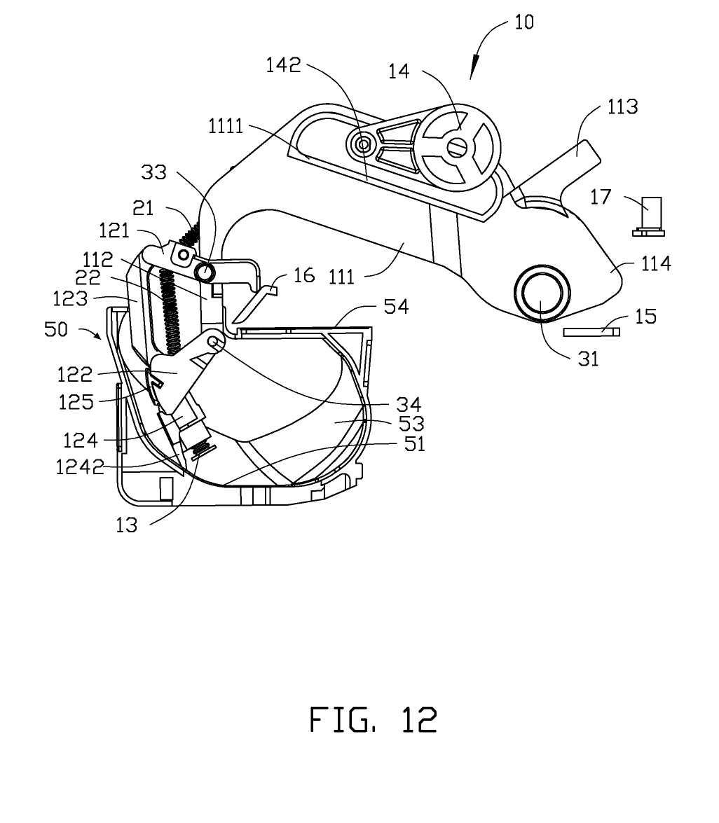

FIG. 12 shows the transfer cam 141 of the transfer mechanism 14 continuing to rotate about the second axis 32 in a clockwise direction. The driving wheel 143 of the transfer mechanism 14 continues driving the main arm 11 to rotate about the first axis 31 in a clockwise direction. The shovel 1242 and the vacuum nozzle 13 move to the lowest position of the storage cavity 53 of the pill box 50.

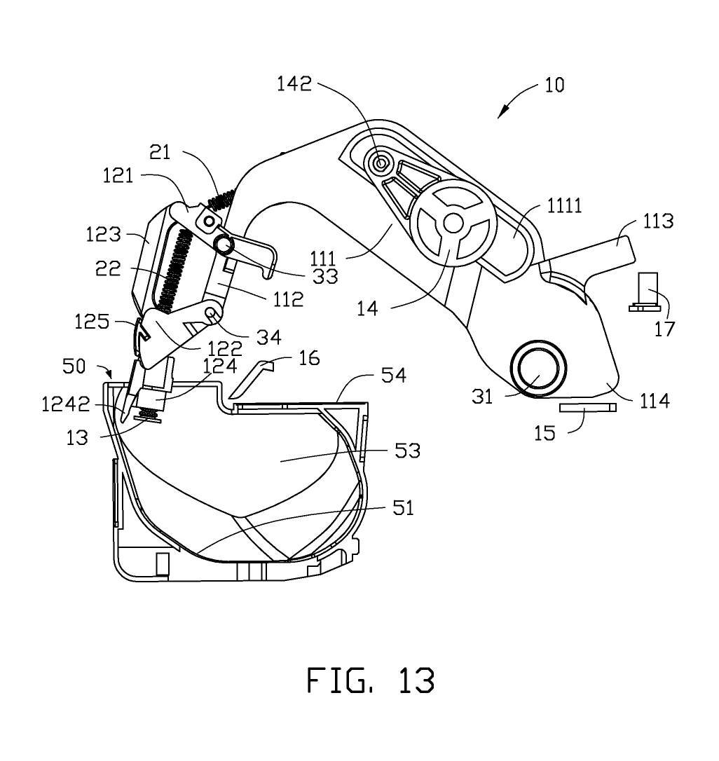

In FIG. 13, the transfer cam 141 of the transfer mechanism 14 continues rotating about the second axis 32 in a clockwise direction. The driving wheel 143 of the transfer mechanism 14 continues driving the main arm 11 to rotate about the first axis 31 in a clockwise direction. The shovel 1242 and the vacuum nozzle 13 move up from the lowest position of the storage cavity 53 of the pill box 50.

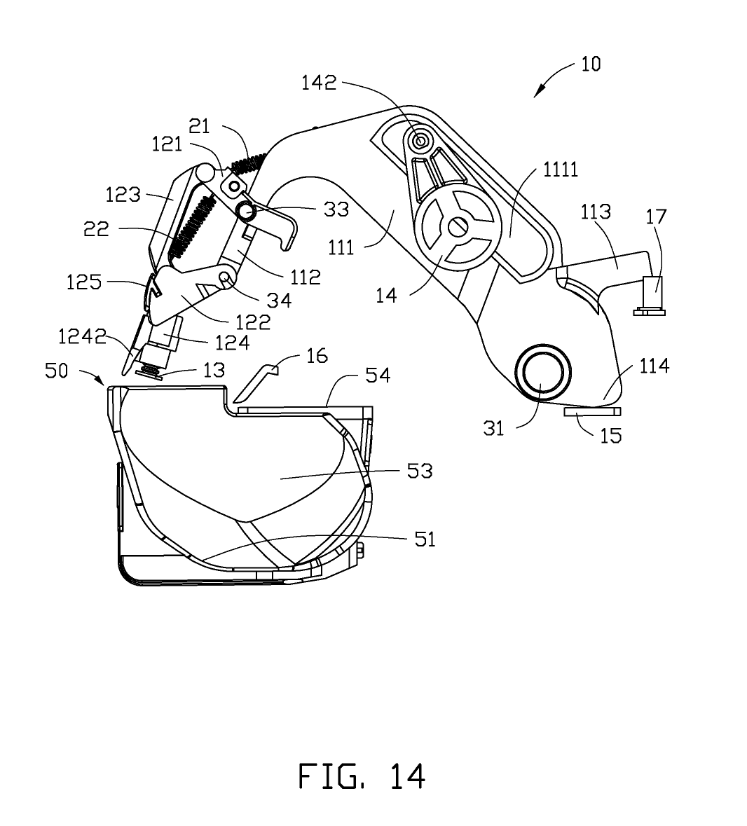

In FIG. 14, the transfer cam 141 of the transfer mechanism 14 continues rotating about the second axis 32 in a clockwise direction. The driving wheel 143 of the transfer mechanism 14 continues driving the main arm 11 to rotate about the first axis 31 in a clockwise direction. At this point, the shovel 1242 and the vacuum nozzle 13 have left the storage cavity 53 of the pill box 50. The breaking portion 113 of the main arm 113 is about to move to interrupt the line between the signal transmitter 171 and the signal receiver 172.

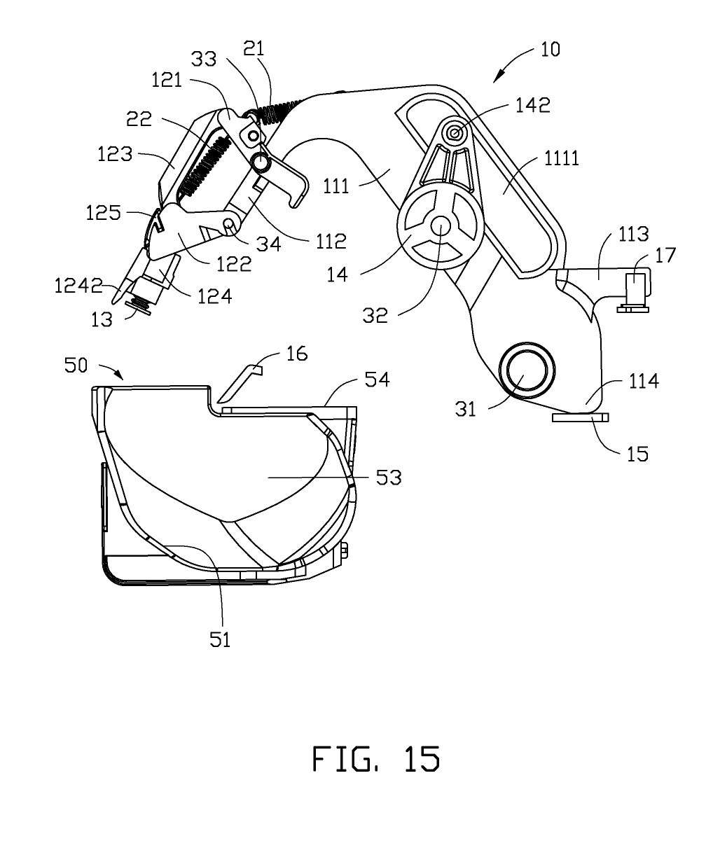

In FIG. 15, the main arm 11 returns to the initial position. The contacting portion 114 of the main arm 11 abuts against the second blocking member 15. The second blocking member 15 prevents the main arm 11 from rotating about the first axis 31 in a clockwise direction. The breaking portion 113 of the main arm 113 is located in a position between the signal transmitter 171 and the signal receiver 172 and breaks the signal transmission between the signal transmitter 171 and the signal receiver 172. The position sensor 17 determines that the main arm 11 is located in the initial position. The transfer cam 141 of the transfer mechanism 14 stops rotating and accordingly the driving wheel 143 of the transfer mechanism 14 stops driving the main arm 11 to rotate.

It is to be understood, however, that even though numerous characteristics and advantages have been set forth in the foregoing description of embodiments, together with details of the structures and functions of the embodiments, the disclosure is illustrative only and changes may be made in detail, including in the matters of shape, size, and arrangement of parts within the principles of the disclosure to the full extent indicated by the broad general meaning of the terms in which the appended claims are expressed. The disclosed embodiments are illustrative examples, and are not intended to limit the scope of the following claims.

What is claimed is:

1. A pill picking apparatus, comprising:
a main arm being rotatable about a first axis, the main arm defining an opening;
a picking device mounted to the main arm and adapted to pick a pill from a pill box; and
a transfer mechanism comprising a transfer cam being rotatable about a second axis and a driving wheel mounted to the transfer cam and received in the opening of the main arm, wherein when the transfer cam rotates about the second axis, the driving wheel is rotated about the second axis by the transfer cam and is adapted to press an edge of the opening of the main arm and to drive the main arm to rotate about the first axis.

2. The pill picking apparatus of claim 1, wherein the transfer mechanism further comprises a driving shaft secured to the transfer cam, the driving wheel is mounted to a free end of the driving shaft, the free end of the driving shaft extends into the opening of the main arm, when the transfer cam rotates about the second axis, the driving shaft is rotated about the second axis by the transfer cam.

3. The pill picking apparatus of claim 2, wherein the first axis is substantially parallel to the second axis.

4. The pill picking apparatus of claim 3, wherein a vertical distance between the first axis and the second axis is three and one haft times greater than a horizontal distance between the first axis and the second axis.

5. The pill picking apparatus of claim 3, wherein the transfer cam defines one or more slots for connecting to a motor.

6. The pill picking apparatus of claim 3, wherein a radius of rotation of the main arm about the first axis is three times greater than a radius of rotation of the driving shaft about the second axis.

7. The pill picking apparatus of claim 3, further comprising a linkage mechanism pivotally mounted to the main arm, wherein the picking device is mounted to the linkage mechanism.

8. The pill picking apparatus of claim 7, wherein the linkage mechanism further comprises a first linkage arm, a second linkage arm, a third linkage arm, and a holder, the first linkage arm and the second linkage arm are pivotally mounted to the main arm, a first end of the third linkage arm is pivotally mounted to the first linkage arm, a second end of the third linkage arm is pivotally mounted to the second linkage arm, the holder is pivotally mounted to the second linkage arm, and the picking device is mounted to the holder.

9. The pill picking apparatus of claim 8, wherein the holder comprises a receiving portion for receiving the picking device and a shovel located on an outer side of the receiving portion.

10. The pill picking apparatus of claim 8, further comprising a first blocking member, wherein when the main arm rotates to a position where the first linkage arm abuts against the first blocking member, the first blocking member is adapted to drive the first linkage arm to rotate relative to the main arm.

11. A pill dispenser, comprising:
a pill box for storing pills;
a main arm being rotatable about a first axis, the main arm defining an opening;
a linkage mechanism pivotally mounted to the main arm;
a picking device mounted to the linkage mechanism and adapted to pick a pill from the pill box; and
a transfer mechanism comprising a transfer cam being rotatable about a second axis and a driving wheel mounted to the transfer cam and received in the opening of the main arm, wherein when the transfer cam rotates about the second axis, the driving wheel is rotated about the second axis by the transfer cam and is adapted to press an edge of the opening of the main arm and to drive the main arm to rotate about the first axis.

12. The pill picking apparatus of claim 11, wherein the transfer mechanism further comprises a driving shaft secured to the transfer cam, the driving wheel is mounted to a free end of the driving shaft, the free end of the driving shaft extends into the opening of the main arm, when the transfer cam rotates about the second axis, the driving shaft is rotated about the second axis by the transfer cam.

13. The pill picking apparatus of claim 12, wherein the first axis is substantially parallel to the second axis.

14. The pill picking apparatus of claim 13, wherein a vertical distance between the first axis and the second axis is three and one haft times greater than a horizontal distance between the first axis and the second axis.

15. The pill picking apparatus of claim 13, wherein the transfer cam defines one or more slots for connecting to a motor, the transfer cam is rotated by the motor.

16. The pill picking apparatus of claim 13, wherein a radius of rotation of the main arm about the first axis is three times greater than a radius of rotation of the driving shaft about the second axis.

17. The pill picking apparatus of claim 13, wherein the linkage mechanism further comprises a first linkage arm, a second linkage arm, a third linkage arm, and a holder, the first linkage arm and the second linkage arm are pivotally mounted to the main arm, a first end of the third linkage arm is pivotally mounted to the first linkage arm, a second end of the third linkage arm is pivotably mounted to the second linkage arm, the holder is pivotably mounted to the second linkage arm, and the picking device is mounted to the holder.

18. The pill picking apparatus of claim 17, wherein the holder comprises a receiving portion for receiving the picking device and a shovel located on an outer side of the receiving portion.

19. The pill picking apparatus of claim 17, further comprising a first blocking member, wherein when the main arm rotates to a position where the first linkage arm abuts against the first blocking member, the first blocking member is adapted to drive the first linkage arm to rotate relative to the main arm.

20. The pill picking apparatus of claim 17, wherein the linkage mechanism further comprises a cover mounted to the second linkage arm and the third linkage arm for covering a gap between the second linkage arm and the third linkage arm.
